(19) United States
(12) Patent Application Publication
(10) Pub. No.: US 2020/0349374 A1
(43) Pub. Date: Nov. 5, 2020

(54) Systems and Methods for Face Recognition

(71) Applicant: Cherry Labs Inc., Wilmington, DE (US)

(72) Inventor: Vasily Morzhakov, Wilmington, DE (US)

(21) Appl. No.: 16/736,301

(22) Filed: Jan. 7, 2020

Related U.S. Application Data
(60) Provisional application No. 62/789,221, filed on Jan. 7, 2019.

(51) Int. Cl. G06K 9/03; G06K 9/62; G06K 9/00

(52) U.S. Cl. CPC G06K 9/036; G06K 9/6256; G06K 9/6284; G06K 9/00711; G06K 9/00288

(57) ABSTRACT

A system for face recognition includes a subsystem, e.g., an autoencoder, for determining whether an image from which a face is to be recognized is of an acceptable or good quality and whether the image includes a face. A subsystem for recognizing the face in an image may be trained using not only good quality images but also some poor quality images that may or may not include a face.

### CROSS-REFERENCE TO RELATED APPLICATIONS

This application claims priority to and benefit of U.S. Provisional Patent Application No. 62/789,221, entitled “Systems and Methods for Facial Recognition,” filed on Jan. 7, 2019, the entire contents of which are incorporated herein by reference.

### FIELD OF THE INVENTION

The techniques described herein are generally related to face recognition and, in particular, to systems and methods for recognizing faces from images captured from video streams.

### BACKGROUND

Typical face recognition applications include granting access to objects, biometric authentication of employees/customers, and grouping photos. In these applications, typically the photos to be analyzed are of good quality. For example, the photos usually have a high-resolution, they are captured with bright illumination, the exposure is adjusted accordingly, the face is directed to the camera, and a contrasting background may be provided. A large number of techniques/models for face recognition that are directed to the above-described applications are known. Many of these techniques are based on the principle that can be generally described as: “Find a face area”→“Select a face code.”

In contrast, face recognition for human tracking may encounter several problems. Images for tracking or images that are captured from video cameras are available from many sources, however. Common examples include video cameras installed for security at the entrances of commercial and government buildings, hospitals, malls, department stores, airports, etc. The images that are obtained from video streams at such locations and from which face recognition may need to be performed are typically of a poor quality. Some factors that contribute to generally low quality images include low resolution, low light, and presence of noise. Also, the face may not be directed to the camera when the image is captured.

Under these conditions, many machine learning algorithms for face recognition that build embeddings (such as Center Loss, Triplet Loss, CosineFace, ArcFace, SphereFace, etc.) may not function correctly because the algorithm may build an embedding for an image without distinguishing between conditions such as the presence of a face and an absence of the face, high or low-quality image, etc., and without making adjustments for the different conditions. Moreover, many of the face datasets (e.g., LFW or MS-Celeb-1M) that are used for training such machine learning algorithms only have good quality (as described above) photos of the faces. Therefore, these datasets may not adequately train an algorithm for recognizing faces in relatively poor quality images.

When the images captured are of a relatively poor quality (e.g., the images are smeared, unsharp, underexposed, and/or overexposed, and/or the face is not directed to the camera or is partially covered, or the image does not include a human face or any face), second level errors (i.e., false acceptance rate) can be as high as 100 times the error rate of a system that excludes low-quality images.

Another problem with recognizing faces from images captured during tracking is that many face recognition systems enforce a quality criterion according to which the face must occupy at least a certain specified portion (e.g., more than 50%, 75% etc.) of the width of the image. This criterion is often unacceptable in human tracking systems where the face in the captured picture can be small but is still recognizable. Sometimes, the face may be captured with a high resolution but still may not be recognizable. Improved techniques and systems are therefore needed to perform face recognition from low quality images.

### SUMMARY

In order to facilitate face recognition from low-quality images, a classifier is provided that can determine whether the image even includes a face and, if so, whether the image is of a certain threshold quality such that face recognition can be performed. In addition, techniques for training the classifier are also provided.

Accordingly, in one aspect, a method is provided for minimizing errors in face recognition. The method includes the steps of: receiving an image from which a face is to be recognized; transforming the image via embedding; and determining, based on a quality of reconstruction of the transformed image by a first autoencoder, whether the image is of an acceptable quality and includes a face.

The method may include recognizing the face in the image, which may be performed using a face recognition engine implemented as a support vector machine (SVM), a single-layer artificial neural network, a set of decision trees, or a second autoencoder. Recognizing the face may include using a latent code generated by the first autoencoder, where the latent code indicates one or more image characteristics (e.g., intensity of background light, size, etc.), or one or more face properties (e.g., distance between the eyes, distance between the nose and the eyes, etc.). The method may include training the face recognition engine using: one or more good quality images; and/or one or more poor quality images; and/or one or more images lacking a face; and/or one or more images having a face. In some embodiments, the method includes training the first autoencoder using: one or more good quality images and/or one or more images having a face.

In another aspect, a system is provide for minimizing errors in face recognition. The system includes a processor in communication with memory, wherein the memory includes instructions which, when executed by a processing unit, program the processing unit to perform one or more operations according to the steps of the methods described above. The processing unit is in electrical communication with a memory module for storing and accessing data generated and required during the performance of the programmed operations. The processing unit may be the same as the processor or may be different from the processor, and the memory unit may the same as the memory or may be different from the memory.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals/labels generally refer to the same or similar elements. In different drawings, the same or similar elements may be referenced using different reference numerals/labels, however. The drawings are not necessarily to scale, emphasis instead being placed upon illustrating aspects of the invention. In the drawings:

FIG. 1 schematically depicts a face recognition system, according to one embodiment.

### DETAILED DESCRIPTION

Various embodiments described herein facilitate efficient, real-time (e.g., within a fraction of a second, a few seconds, a few minutes, etc.) face recognition from potentially low quality images, such as those captured during tracking and/or from video cameras. In one embodiment, evaluation of the identified face is performed using various image parameters. In particular, one or more of the following parameters may determine the quality of the face:

1. Image size.

2. The distance between the eyes.

3. The relationship between the eyes and the nose.

4. The reliability with which the face is recognized and a person is identified, if the face-recognition algorithm provides a measure of reliability.

5. Sum of Laplacians in the image.

From these parameters a “Good”/“Bad” face classifier may be built. The classifier builds on the basis of a database of examples. The classifier may be a support vector machine (SVM), a single-layer artificial neural network, or a set of decision trees. The classifier determines whether the image include a “good” face that can be recognized or a “bad” face that cannot be recognized.

In some embodiments, face recognition and/or classification (i.e., “good”/“bad” face or face/non-face) is performed using an artificial neural network (ANN). The ANN may be retrained using images from a publicly available database called ImageNet™ which contains millions of annotated or labelled images of various objects. A sample database used to train the ANN includes several images that are not of good quality. For example, conditions such as lighting, exposure, contrast, and focus, are purposefully selected to produce low quality images, and images are captured in public places, such as on streets. In some cases, defective lenses are used for capturing the images. The sample database also includes some good-quality images that are obtained from publicly available training datasets. In various embodiments, the resulting ANN builds a face/non-face confidence level.

In some embodiments, face recognition and/or classification is based on embedding space. For example, when training a neural network, a separate embedding space may be added, where an explicit “good face”/“bad face” classification or face/no-face classification is introduced. In the context of machine learning (ML), embedding generally means projecting an input from the input space onto a different representation space. For face recognition, in particular, we can project (i.e., embed) a face into a space in which face matching can be more reliable. Consider a projection function f( ). Given two inputs, i.e., images of faces x₁ and x₂, we can find an embedding space such that some (e.g., Euclidean) distance measure between the face embeddings corresponds to the similarity between the faces.

A naive Euclidean distance measure such as d=|x₁−x₂| is usually inadequate due to noise, lighting changes, view point changes, etc. A number of these factors do not pertain directly to face matching but can nevertheless impact face matching and can result in erroneous matches and/or erroneous failure to match.

Embedding can address this problem by projecting or embedding the faces onto a new space where d=|z₁−z₂| and z=f(x). The embedding function can be an ANN, e.g., a convolutional neural network (CNN). During training, two identical ANNs/CNNs may be used to project two different images xᵢ and xⱼ. Thus, z₁=(xᵢ, W) and z₂=f₂(xⱼ, W). Even though the two ANNs/CNNs are denoted f₁ and f₂, respectively, these are identical functions having the same weights W. If xᵢ and xⱼ are images of face of the same person, the weights W are selected such that the distance measure d_{i,j}=|zᵢ−zⱼ| is minimized. Otherwise, if xᵢ and xⱼ are images of faces of different persons, the weights W are selected such that the distance measure d_{i,j}=|zᵢ−zⱼ| is maximized. Likewise, if xᵢ (or xⱼ) is an image of a poor quality or an image that does not include a face, the distance measure d_{i,j}=|zᵢ−zⱼ| is maximized.

The selection of the optimized weights W defines the projection function (also called embedding function) f( ) where z=f(x). To perform face matching, recognition, or classification (i.e., “good”/“bad” face or face/non-face), an input image x is first projected as z=f(x), and z (and not x) is provided as an input to the classifier performing face recognition and/or classification.

In some embodiments, the face recognition/classification is based on the autoencoding technique. In face recognition a projection to embedding space may be provided by an artificial neural network, as described above. Loss functions are optimized to increase the distance between different faces and to decrease it for the faces of same persons, also as described above. This embedding space is used for the reconstruction by a decoder. The embedded space generally does not relate to face identification and is not used in identification-loss optimization, but it contains the information about other aspects that can affect face recognition, such as light condition, the orientation of the face, etc.

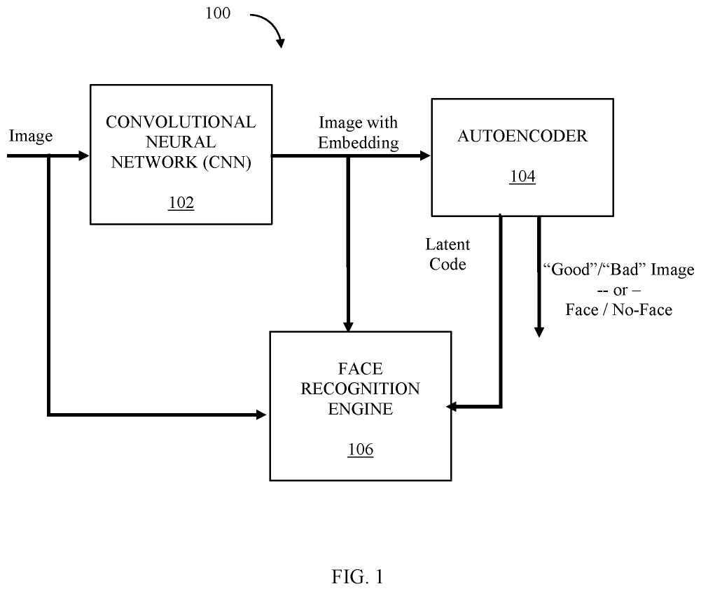

With reference to FIG. 1, a face recognition (also called matching)/classification system 100 includes a CNN 102 that provides the embedding function and a classifier implemented as an autoencoder 104. An autoencoder (such as the autoencoder 104) includes an encoder and a decoder. The encoder encodes, i.e., transforms input data into a latent-space representation (also called a latent vector or code) typically having a lower dimension than that of the input data. The code can indicate certain latent information about, e.g., certain properties or characteristics of, the input data. The decoder receives the latent-space representation and reconstructs the input data, which is provided as the output of the autoencoder. Due to the reduction in dimensionality, the reconstruction is typically not perfect, i.e., the output is different from the input.

During training, where in the input is known, the difference between the input and output can be minimized by adjusting the weights of the autoencoder. In general, the training data set is assumed to define the probability density of the input data. Thus, the more the training samples are placed around a point in the input space, the better the autoencoder will reconstruct the input there. Also, as there is a latent vector in the bottleneck of the autoencoder, if an input vector is projected to the area in the latent space that was not involved previously in training, then this input vector can be determined to be unlikely. An unlikely input vector can also indicate an anomaly.

The whole system 100 may be trained using a data set that includes several good quality images having faces. An example of such a data set is the above described publicly available database called ImageNet™ which contains millions of annotated or labelled images of various objects, including faces. During training, the decoder of the autoencoder 104 starts to reconstruct the input image if it is of a good quality and contains a face. Otherwise the reconstruction is far from ideal.

This approach is thus based, at least in part, on the quality of reconstruction of the latent code by the decoder of an autoencoder that receives as input an image having embedding space. Good quality of reconstruction indicates “good” face, i.e., good quality image and presence of a face in the image that is analyzed. Poor quality reconstruction indicates “bad” face, i.e., poor quality image or absence of a face in the image that is analyzed.

The face recognition engine 106 may be implemented as a support vector machine (SVM), a single-layer artificial neural network, a set of decision trees, or another autoencoder. The face recognition engine 106 may be trained using a combination of good quality images and poor quality images, where some of the images may not include a face. The face recognition engine 106 may perform face recognition only if the autoencoder 104 determines that the image is of a good quality, determined by the magnitude of the reconstruction error and/or the image includes a face. The face recognition engine 106 may perform face recognition using the original image or the image generated by the CNN that has embedding. The face recognition engine 106 may also use the latent code derived by the autoencoder 104, where the latent code may include information about the image and/or the face therein, such as light condition, the orientation of the face, etc.

In some examples, some or all of the processing described above can be carried out on a personal computing device, on one or more centralized computing devices, or via cloud-based processing by one or more servers. In some examples, some types of processing occur on one device and other types of processing occur on another device. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

A computing system used to implement various embodiments may include general-purpose computers, vector-based processors, graphics processing units (GPUs), network appliances, mobile devices, or other electronic systems capable of receiving network data and performing computations. A computing system in general includes one or more processors, one or more memory modules, one or more storage devices, and one or more input/output devices that may be interconnected, for example, using a system bus. The processors are capable of processing instructions stored in a memory module and/or a storage device for execution thereof. The processor can be a single-threaded or a multi-threaded processor. The memory modules may include volatile and/or non-volatile memory units.

The storage device(s) are capable of providing mass storage for the computing system, and may include a non-transitory computer-readable medium, a hard disk device, an optical disk device, a solid-date drive, a flash drive, or some other large capacity storage devices. For example, the storage device may store long-term data (e.g., one or more data sets or databases, file system data, etc.). The storage device may be implemented in a distributed way over a network, such as a server farm or a set of widely distributed servers, or may be implemented in a single computing device.

The input/output device(s) facilitate input/output operations for the computing system and may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices. In some examples, mobile computing devices, mobile communication devices, and other devices may be used as computing devices.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium.

Various embodiments and functional operations and processes described herein may be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

The phraseology and terminology used herein is for the purpose of description and should not be regarded as limiting. The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A method for minimizing errors in face recognition the method comprising the steps of:
receiving an image from which a face is to be recognized;
transforming the image via embedding; and
determining, based on a quality of reconstruction of the transformed image by a first autoencoder, whether the image is of an acceptable quality and includes a face.

2. The method of claim 1, further comprising:
recognizing the face in the image using a face recognition engine comprising one of: a support vector machine (SVM), a single-layer artificial neural network, a set of decision trees, or a second autoencoder.

3. The method of claim 2, wherein recognizing the face comprises using a latent code generated by the first autoencoder, the latent code indicating one or more image characteristics or one or more face properties.

4. The method of claim 2, further comprising training the face recognition engine using:
one or more good quality images;
one or more poor quality images;
one or more images lacking a face; or
one or more images having a face.

5. The method of claim 1, further comprising training the first autoencoder using:
one or more good quality images; or
one or more images having a face.

6. A system for minimizing errors in face recognition, comprising:
a processor; and
a memory in communication with the processor and comprising instructions which, when executed by a processing unit in communication with a memory unit, program the processing unit to:
receive an image from which a face is to be recognized;
transform the image via embedding; and
determine, based on a quality of reconstruction of the transformed image by a first autoencoder, whether the image is of an acceptable quality and includes a face.

7. The system of claim 6, wherein:
the instructions program the processing unit to operate as the first autoencoder.

8. The system of claim 6, wherein to recognize the face in the image:
the instructions program the processing unit as a face recognition engine configured as one of: a support vector machine (SVM), a single-layer artificial neural network, a set of decision trees, or a second autoencoder.

9. The system of claim 8, wherein for recognizing the face, the instructions program the processing unit to use a latent code generated by the first autoencoder, the latent code indicating one or more image characteristics or one or more face properties.

10. The system of claim 8, wherein the instructions further program the processing unit to train the face recognition engine using:
one or more good quality images;
one or more poor quality images;
one or more images lacking a face; or
one or more images having a face.

11. The system of claim 6, wherein the instructions further program the processing unit to train the first autoencoder using:
one or more good quality images; or
one or more images having a face.
